(19) United States
(12) Patent Application Publication
(10) Pub. No.: US 2026/0347005 A1
(43) Pub. Date: Nov. 5, 2026

(54) EXTERNAL DRIVE APPARATUS FOR A HYDRAULIC PUMP

(71) Applicant: ROTORWELD ENGINEERING LIMITED, Mauku (NZ)

(72) Inventor: Samuel HENDERSON, Mauku (NZ)

(21) Appl. No.: 19/488,240

(22) PCT Filed: May 31, 2024
(86) PCT No.: PCT/IB2024/055340

§ 371 Date: Nov. 26, 2025

(30) Foreign Application Priority Data
Jun. 1, 2023 (EP) 23176752.6

(51) Int. Cl. B64F 5/40; B64F 5/60

(52) U.S. Cl. CPC B64F 5/40; B64F 5/60

(57) ABSTRACT

An external drive apparatus for a hydraulic pump of an aircraft is provided. The hydraulic pump is operable to drive the hydraulic pump of an aircraft when the aircraft's engine is not operating, and to do so without disassembly of the hydraulic pump or breaking into the hydraulic system. The external drive apparatus has a mounting portion which is mountable to the aircraft and configured to locate the apparatus relative to a drive pulley of the hydraulic pump of the aircraft. The external drive apparatus also has a belt drive assembly that has a belt which is locatable around the drive pulley, and an electric motor arranged to operate the belt drive assembly to drive the hydraulic by its own drive pulley via the belt of the drive apparatus.

### FIELD OF TECHNOLOGY

The present invention relates to a tool for use in maintenance and testing of an aircraft, and more particularly but not solely to an external drive apparatus for a hydraulic pump of an aircraft and specifically for a helicopter.

### BACKGROUND

Aircraft, and more particularly helicopters, commonly include hydraulic systems for aiding in the operation of systems on the aircraft, such as control surfaces of the aircraft. The hydraulic systems may be driven by a hydraulic pump, which pressurises the hydraulic system.

Such hydraulic pumps are commonly driven by the engine of the aircraft. In the case of fixed wing aircraft, hydraulic pumps are commonly driven directly by the engine such as from the drive shaft. In the case of helicopters, the hydraulic pump may be driven by the engine indirectly through a transmission.

During maintenance and testing of a helicopter it may be necessary to test the hydraulic system for leaks and to test the performance of the flight control systems for freedom of movement, to identify potential issues. Such testing may be required after the replacement of flight control or hydraulic system components.

In some helicopters with hydraulically boosted flight control systems, for example the Airbus AS350 and EC130, the manufacturer instructs the use of an external hydraulic supply system in conducting these hydraulic system leak and flight performance test while the helicopter is on the ground. The helicopter's hydraulic system is broken into and the external hydraulic supply system, which includes a hydraulic pump, is connected. The external hydraulic supply system is then used to pressurise the helicopter's hydraulic system to enable the necessary tests to be conducted. The cost and cumbersome nature of such dedicated external hydraulic supply systems and need to break into the helicopter's hydraulic system may be barriers to conducting this testing as recommended by the manufacturer.

Post-maintenance checks of a helicopter's flight control and hydraulic systems are commonly carried out during a ground run-up of the helicopter, where the helicopter's engine is started and run at a nominal speed on the ground. The nominal speed operation of the engine may provide sufficient drive to the hydraulic pump to then test the hydraulic system and flight controls. However, the degree of operation of the flight control surfaces may be limited, as taking the flight controls towards their limits even at this nominal engine speed may be sufficient to cause the helicopter to tip over.

### SUMMARY

It is an object of the disclosure to provide an improved external drive apparatus for use in the maintenance or testing of the hydraulic system and control surfaces of an aircraft and particularly a helicopter which addresses or ameliorates one or more disadvantages or limitations associated with the prior art, or at least to provide the public with a useful choice.

Additionally or alternately, it may be an object of the disclosure to provide an external drive apparatus for driving the hydraulic pump of an aircraft and particularly a helicopter when the helicopter is on the ground.

Additionally or alternatively, it may be an object of the disclosure to provide an external drive apparatus for driving the hydraulic pump of a helicopter having a belt-driven hydraulic pump when the helicopter is on the ground. For example, the external drive apparatus may be for driving the hydraulic pump of an Airbus AS350 or Airbus EC130 helicopter.

Additionally or alternatively, it may be an object of the disclosure to provide an external drive apparatus for driving the hydraulic pump of a helicopter externally, in the absence of the operation of the helicopter's engine, without breaking into the hydraulic system of the helicopter.

Additionally or alternatively, it may be an object of the disclosure to provide an external drive apparatus for driving the belt-driven hydraulic pump of a helicopter, where a belt of the external drive apparatus which drives the hydraulic pump in use is self-tensioned.

Additionally or alternatively, it may be an objection the disclosure to provide an external drive apparatus for driving the belt driven hydraulic pump of a helicopter, where the external drive apparatus is able to accommodate a range of lateral positions of a drive pulley of the hydraulic pump relative to the external drive apparatus.

In a first aspect, the disclosure provides for an external drive apparatus for a hydraulic pump of an aircraft, the apparatus comprising:
a mounting portion mountable to the aircraft and configured to locate the apparatus relative to a drive pulley of the hydraulic pump of the aircraft,
a belt drive assembly including a belt locatable about the drive pulley when the mounting portion is mounted to the aircraft, and
an electric motor arranged to operate the belt drive assembly to drive the hydraulic pump by its drive pulley and the belt.

The mounting portion is mountable to a body of the hydraulic pump or structures adjacent thereto. For example, the mounting portion may be mountable directly to the body of the hydraulic pump. In other examples where and adjacent structure exists, for example a bracket or other structural component near to the pump body, it will be appreciated that the mounting portion may be configured to be mountable to such a structure in addition to or alternatively to mounting to the body of the hydraulic pump.

The mounting portion includes a locating feature configured to couple with a feature of the body of the pump.

The feature of the body of the pump is a recess, and the locating feature comprises a lug which is insertable into the recess.

The recess is located on an opposite side of the pump from the drive pulley.

The recess is a pre-existing cast bore on the body of the pump. For example, the cast bore may be a bore formed during the manufacture of the body of the pump, prior to the use of the external drive apparatus on the pump.

A profile of the lug corresponds with a profile of the recess, such that when the lug is inserted into the recess, relative rotational movement between the body of the pump and the mounting portion is limited a single degree of freedom.

When the lug is inserted into the recess, relative linear movement between the body of the pump and the mounting portion is limited to a single degree of freedom.

The mounting portion is engaged to the aircraft by at least one fastener, wherein when the fasteners are engaged a longitudinal axis of each at least one fastener is parallel to an axis of insertion of the lug into the recess.

When the mounting portion is engaged to the aircraft by the at least one fastener, relative movement between the mounting portion and the aircraft and more particularly the pump of the aircraft is substantially prevented.

The belt drive assembly is removably pivotably connected to the mounting portion.

The mounting portion and belt drive assembly together comprise a pivot and a component which is removably locatable on the pivot.

The mounting portion comprises the pivot and the belt drive assembly includes a slot which is insertable onto the pivot to removably pivotably connect the belt drive assembly and the mounting portion.

A longitudinal axis of the pivot of the mounting portion is parallel to a longitudinal axis of the lug of the mounting portion, along which the lug is insertable into the recess.

The mounting portion and belt drive assembly together further comprise an arcuate slot radially spaced away from the pivot and a member slidable therein, and a selective frictional coupling between the arcuate slot and the member, such that the member and slot may slide relative each other but be selectively coupled with each other at a desired location of the member within the arcuate slot.

The member and slot are relatively slidable by relative rotation of the belt drive assembly about the pivot of the mounting portion.

The belt drive assembly has a housing and projecting therefrom a loop of the belt, wherein the belt drive assembly is configured to limit retraction of the loop of the belt into the housing when the belt is not located about the drive pulley of the hydraulic pump of the aircraft.

The belt drive assembly is configured to substantially prevent retraction of the loop of the belt into the housing between an in-use condition where the loop of the belt is located about the drive pulley of the hydraulic pump and a non-use condition where the loop of the belt is unrestrained. Were the belt to be retracted within the housing there may be the potential for it to become jammed, such as by becoming unseated from the pulleys on which it runs and/or by becoming coiled onto itself. It may be desirable to prevent or at least limit the retraction of the loop of the belt into the housing when the belt is not engaged and in use about the drive pulley.

The housing of the belt drive assembly defines an enclosed path for the belt about one or more pulleys and an outlet of the housing from which the loop of the belt projects.

The enclosed path is enclosed relative to an inner face and an outer face of the belt.

A width of the one or more pulleys and enclosed path of the belt drive assembly is greater than a width of the belt, such that the belt is operable in different laterally displaced positions relative to the housing.

The greater width of the one or more pulleys and enclosed path than the belt enables the belt, in use, to walk laterally relative to the housing to accommodate a range of lateral locations of the drive pulley of the hydraulic pump relative to the mounted location of the belt drive assembly.

The belt is a grooved belt for locating about a grooved drive pulley of the hydraulic pump, but the one or more pulleys of the housing are non-grooved.

Each of the pulleys of the housing are non-grooved.

The belt drive assembly comprises an input pulley which is driveable by the electric motor and two idler pulleys.

The input pulley and idler pulleys are configured to reverse the drive direction of the belt with respect to a drive direction of the electric motor.

The enclosed path for the belt comprises a path within the housing that is enclosed above and below the belt between each successive one of the input pulley, the two idler pulleys, and the opening of the housing.

When the mounting portion is mounted to the aircraft and the belt drive assembly is pivotably connected to the mounting portion, the combined centre of mass of the belt drive assembly and electric motor are located laterally away from both the hydraulic pump of the aircraft and the pivotable connection of the belt drive assembly with the mounting portion, such that the weight of the belt drive assembly and electric motor provide tension to the belt about the drive pulley of the hydraulic pump.

The electric motor is powered by a battery power source.

The electric motor is powered by a mains power source.

The electric motor is comprised as part of an electric power tool.

In another aspect, the disclosure provides a tool for providing auxiliary mechanical operation of an engine-driven hydraulic pump of an aircraft when the engine is not in operation, the tool being mountable to the aircraft and comprising an electric motor driven belt which, when the tool is mounted to the aircraft, is configured to align with a drive pulley of the hydraulic pump and when the belt is engaged therewith, to selectively operate the hydraulic pump in the absence of operation of the aircraft engine.

In another aspect, the disclosure provides a tool for providing auxiliary mechanical operation of an engine-driven hydraulic pump of an aircraft when the engine is not in operation, the tool mountable to an aircraft having a fully assembled hydraulic system but for removal of an engine drive belt from the drive pulley of the hydraulic pump.

In another aspect, the disclosure provides a tool for providing auxiliary mechanical operation of an engine-driven hydraulic pump of an aircraft having a flight-ready hydraulic system but for the removal of a drive belt from a drive pulley of the hydraulic pump.

In another aspect, the disclosure provides an external drive apparatus for a hydraulic pump of an aircraft is provided. The hydraulic pump is operable to drive the hydraulic pump of an aircraft when the aircraft's engine is not operating, and to do so without disassembly of the hydraulic pump or breaking into the hydraulic system. The external drive apparatus has a mounting portion which is mountable to the aircraft and configured to locate the apparatus relative to a drive pulley of the hydraulic pump of the aircraft. The external drive apparatus also has a belt drive assembly that has a belt which is locatable around the drive pulley, and an electric motor arranged to operate the belt drive assembly to drive the hydraulic by its own drive pulley via the belt of the drive apparatus.

The term “axis” as used in this specification means the axis of revolution about which a line or a plane may be revolved to form a symmetrical shape. For example, a line revolved around an axis of revolution will form a surface, while a plane revolved around an axis of revolution will form a solid.

As used herein the term “and/or” means “and” or “or”, or both.

For the purpose of this specification, where method steps are described in sequence, the sequence does not necessarily mean that the steps are to be chronologically ordered in that sequence, unless there is no other logical manner of interpreting the sequence.

The term “comprising” as used in the specification and claims means “consisting at least in part of.” When interpreting each statement in this specification that includes the term “comprising,” features other than that or those prefaced by the term may also be present. Related terms “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims.

The disclosures and the descriptions herein are purely illustrative and are not intended to be in any sense limiting.

Other aspects of the invention may become apparent from the following description which is given by way of example only and with reference to the accompanying drawings.

### BRIEF DESCRIPTION OF THE DRAWINGS

Preferred embodiments of the invention will be described by way of example only and with reference to the drawings, in which:

FIG. 1 is a view of an external drive apparatus which is associated with a hydraulic pump to externally drive the pump.

FIG. 2 is a view of a hydraulic pump.

FIG. 3 is another view of the hydraulic pump of FIG. 2.

FIG. 4 is a view of a mounting portion of an external drive apparatus.

FIG. 5 is another view of the mounting portion of FIG. 3.

FIG. 6 is a side view of the mounting portion of FIGS. 3 and 4.

FIG. 7 is a view of the mounting portion aligned with a pump for mounting to it.

FIG. 8 is a view of a mounting portion mounted to a hydraulic pump.

FIG. 9 is a view of a belt drive assembly and electric motor for an external drive apparatus.

FIG. 10 is a side view of a partially disassembled belt drive assembly, showing the internals of the belt drive assembly.

FIG. 11 is another view of the partially disassembled belt drive assembly of FIG. 10.

FIG. 12 is a view of a belt drive assembly pivotably mounted to a mounting portion which is mounted to a hydraulic pump.

FIG. 13 is a side view of a belt drive assembly and electric motor attached to a mounting portion which is mounted to a hydraulic pump, where the belt of the belt drive assembly has been located about the drive pulley of the pump.

FIG. 14 shows the side view of FIG. 12, where the belt drive assembly and electric motor have been rotated about the mounting portion to tension the belt on the drive pulley of the pump.

### DETAILED DESCRIPTION

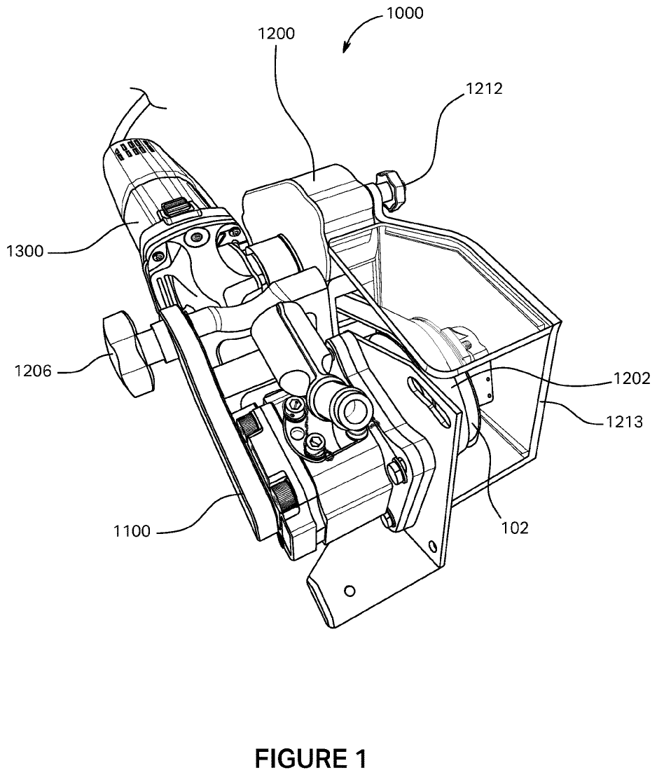

An external drive apparatus 1000 according to an aspect of the disclosure is shown in FIG. 1. The external drive apparatus 1000 is mounted a hydraulic pump 100 which in use is mounted to an aircraft. The external drive apparatus 1000 has a mounting portion 1100 which is mountable to the aircraft, or as illustrated in FIG. 1, particularly to the hydraulic pump 100 and an associated mounting bracket of the pump, which may be used to mount the pump to the aircraft.

The external drive apparatus 1000 has a belt drive assembly 1200 which includes a belt which is for locating about a drive pulley 102 of the pump 100 to drive the pump. An electric motor 1300 is provided in association with the belt drive assembly 1200 to drive the belt 1202 and in turn the hydraulic pump 100. The mounting portion 1100 is configured to locate the belt drive assembly 1200 relative to the drive pulley 102 of the pump 100 so that the belt 1202 can be used to operate the drive pulley 102.

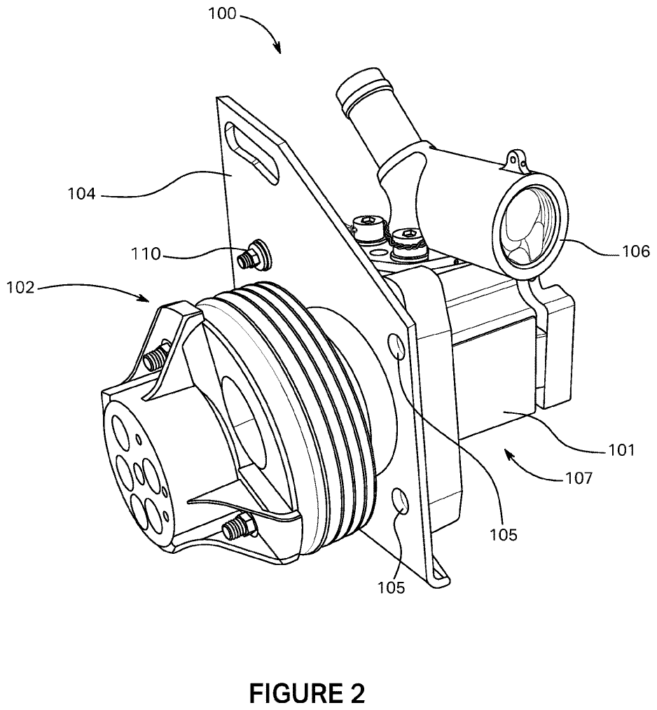

An example hydraulic pump 100 for an aircraft is shown in FIG. 2. In use, the hydraulic pump 100 is mounted to an aircraft, for example to the airframe. The hydraulic pump 100 may be of any commercially available configuration, for example it may be a gear pump, a vane pump, or a piston pump. The hydraulic pump 100 has a pump body 101 which contains the internals of the pump. The hydraulic pump inlet 106 and an outlet, in the arrangement of FIG. 2 at an underside of the pump body indicated by the arrow 107, are respectively for connection to the hydraulic system of the aircraft, and in use the hydraulic pump 100 provides hydraulic power to the hydraulic system such as for operating control surfaces of the aircraft.

The hydraulic pump 100 shown in FIG. 2 is belt driven. The pump 100 is coupled to the pump drive pulley 102. When mounted to an aircraft, a belt is provided about the pump drive pulley 102. The belt is driven by aircraft's engine, for example from the main driveshaft or a secondary driveshaft, to energise the hydraulic pump 100 and provide hydraulic power to the aircraft.

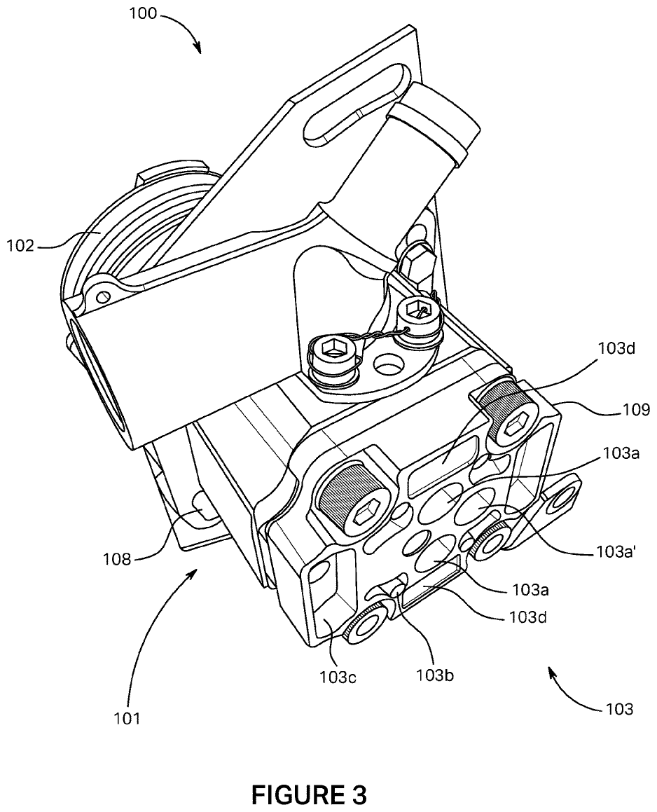

As seen in FIG. 2, a bracket 104 is provided between a pump body 101 of the pump 100 and the drive pulley 102. The bracket 104 is for mounting of the pump 100 to the aircraft. The pump 100 is in turn mounted to the bracket by fixtures 110 which pass through respective holes 105 and 108 of the bracket 104 and pump body 101. In the configuration illustrated in FIGS. 2 and 3, the bracket 104 and pump body 101 have four respective sets of holes, to accommodate four fixtures 110 to secure the pump body 101 and bracket 104 together. These holes and fixtures may be utilised in the connection of an external hydraulic drive apparatus 1000 to the hydraulic pump 100 of an aircraft according to the disclosure.

While illustrated in FIG. 2 as being securable together with removable fixtures 110 in the form of bolts with nuts and washers, the pump body 101 may be mounted to the bracket 104 by other methods. For example, in one alternate configuration the bracket 104 may include one or more studs formed integrally with it. The pump body 101 may be inserted onto the stud or studs through the hole or holes I the pump body 101, then the pump body 101 may be secured onto the studs and consequently to the bracket 104 such as by one or more nuts and optionally washers which may be threaded onto the stud or studs.

FIG. 3 shows the side of the pump body 101 opposite to the drive pulley 102. As seen in FIG. 3, a cover 109 is mounted to enclose the pump body 101. The cover 109 includes features 103 formed in it. The features may be recessed into the cover. These features may for example be casting bores where the cover 109 is formed by casting. The cover 109 include two features 103a which have a circular profile. The cover 109 illustrated in FIG. 3 also has other features 103b-d each with other different non-circular profiles. While illustrated as being formed in the cover 109 of the pump 100, it will be appreciated features such as the casting bore features 103a-d may in different arrangements be present on other parts of the hydraulic pump, such as on the pump body. As will be described, one or more of such features of a hydraulic pump 100 may be utilised for mounting an external hydraulic drive apparatus to it.

The external hydraulic drive apparatus 1000 according to the disclosure is for energising the hydraulic system of an aircraft having an engine-driven hydraulic pump, without requiring either the operation of the engine or breaking into the hydraulic system.

An external hydraulic drive apparatus 1000 may include a mounting portion 1100. The mounting portion 1100 is for mounting a remainder of the external hydraulic drive apparatus to the aircraft to operate the hydraulic pump and energise the hydraulic system.

The mounting portion 1100 is configured to mount to the aircraft and locate the remainder of the external drive apparatus adjacent relative to the drive pulley of the hydraulic pump so that the drive pulley may be driven. The mounting portion 1100 may be configured to mount to the airframe or another component of the aircraft. In the example illustrated in FIGS. 1-14, the mounting portion 1100 is configured to mount to the hydraulic pump 100 and the bracket 104 through which the pump 100 is to be mounted to the aircraft.

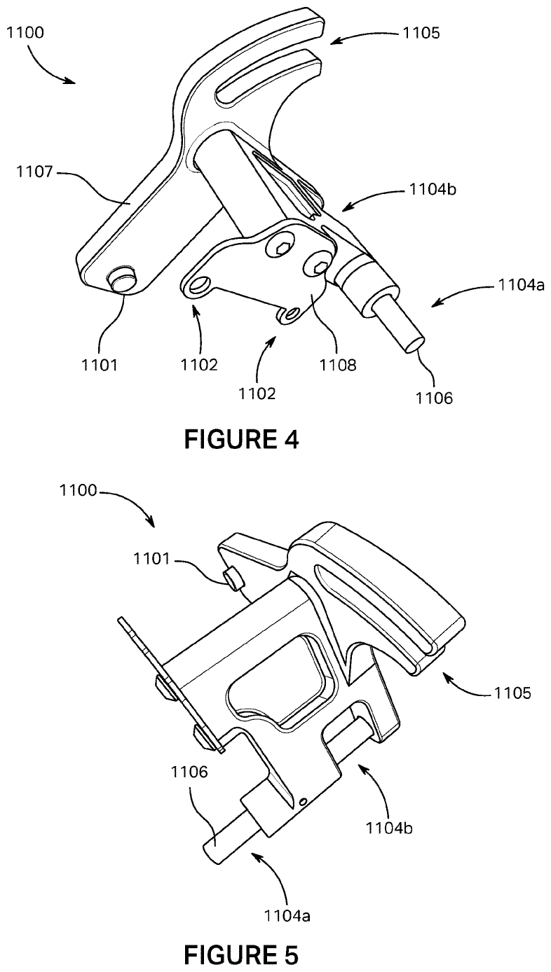

FIGS. 4 and 5 are views of a mounting portion 1100 for an external hydraulic drive apparatus. The mounting portion 1100 includes a lug 1101 and mounting holes 1102. The lug 1101 is sized and configured to be insertable within one of the features 103 of the cover 109 of the pump body 101. Specifically, the lug 1101 of FIGS. 4 and 5 has a circular profile to correspond with the circular profile of one of the features 103a of the cover 109 of the pump body 101. The lug 1101 is to be insertable into one of the features 103a, and when inserted is to be constrained by the feature. For example, when the circular lug 1101 is inserted into one of the features 103a, the movement of the mounting portion 1100 may be restricted to only one rotational degree of freedom about a mutual axis of the lug 1101 and feature 103a, and one linear degree of freedom along the mutual axis.

In the illustrated arrangement, the lug 1101 of the mounting portion 1100 is configured to mount to the feature 103a′ of the cover 109.

While the illustrated lug 1101 has a circular profile for being inserted into the features 103a, in other configurations the lug 1101 may be formed to correspond with the profile of any other casting bore in the cover 109 or body 101 of a hydraulic pump 100. For example, the lug 1101 may be formed to correspond with the profile of another of the features 103b-d of the cover 109 as seen in FIG. 3.

At least a leading edge of the lug 1101 may be tapered to facilitate insertion of the lug 1101 into the desired feature 103 of the pump 100. For example as seen in FIGS. 4 and 5, the cylindrical lug 1101 has a tapered leading edge.

While the illustrated configuration has a single lug 1101 for insertion into a single feature 103a′, in other arrangements the mounting portion 1100 may include more than one lug 1101, for insertion into a corresponding number of different features 103 of the pump.

The mounting holes 1102 are arranged to correspond with holes 108 in the body 101 of the pump and corresponding holes 105 in the bracket 104. As illustrated in FIGS. 4 and 5, the mounting portion 1100 has two mounting holes 1102 which correspond with two sets of the holes 105 and 108. These holes may preferably be the holes which are most easily accessible from outside the aircraft when the hydraulic pump 100 is assembled to it.

The mounting holes 1102 are configured on the mounting portion 1100 to align with the desired holes 105 and 108 when the lug 1101 is inserted into the feature 103a′ the mounting portion 1100 is suitably rotated within the feature 103a′.

To mount the external drive apparatus 1000 to drive the hydraulic pump 100, one or more of the fixtures 110 connecting the bracket 104 and pump body 101 may first be removed. For example as is shown in FIGS. 2 and 3, two fixtures 110 have been removed to expose the holes 105 and 108. The lug 1101 may be inserted into the feature 103a′, and the mounting portion 1100 rotated relative to the pump 100 to align the mounting holes 1102 with two corresponding sets of holes 105 and 108 in the bracket 104 and pump body 101. Once aligned, the fixtures 110 may be reinserted through the holes 105, 108, and 1102 to secure the bracket 104, pump body 101, and mounting portion 1100 together. With the fixtures 110 in place, the mounting portion 1100 is securely fixed to the pump 100, with no remaining degrees of freedom relative to it.

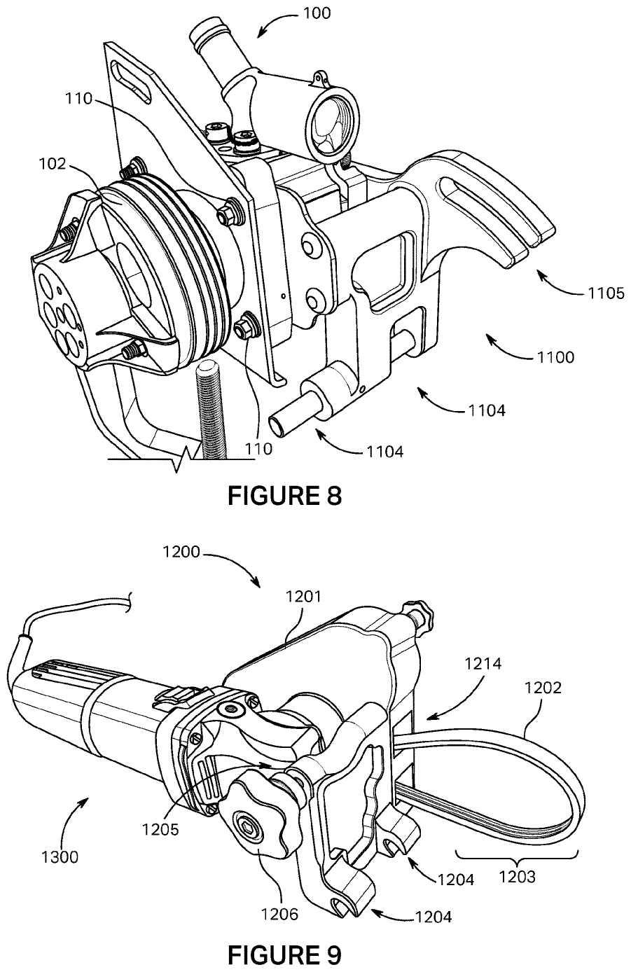

FIG. 7 shows the mounting portion 1100 with its lug 1101 partially inserted into the feature 103a′ of the pump 100. FIG. 8 shows the mounting portion 1100 fully mounted to the pump 100 and bracket 104, with the fixtures 110 securing the components together.

While illustrated as provided on a separate plate 1108 which is fastened to a unitary body 1107 of the mounting portion 1100, in other configurations the mounting holes 1102 may be integrally formed with a body of the mounting portion 1100, such as being a contiguous machined part.

While illustrated as mounting to the pump 100 utilising a lug 1101, in other configurations the mounting portion 1100 may be mounted to the pump in other ways. For example, in some configurations the mounting portion 1100 may be mounted solely to the pump at the interface of the pump with the mounting bracket. In at least some configurations however it may be desirable to mount to the pump at two spaced apart locations, to provide torsional stability between the external drive apparatus and the pump under when the external drive apparatus is operating. While the insertion of a lug into a casting bore of the pump has been described as one option for providing a second connection point spaced apart from the mounting bracket, other methods of connection may be utilised. For example, the mounting portion may define a female portion into which an end of the pump at or towards the cover 109 may be inserted. In another example, the mounting portion may be clamped onto the pump at or towards the cover 109.

Returning to FIGS. 4 and 5, further details will now be described of how the mounting portion 1100 may be configured to allow the remainder of the external drive apparatus to be mounted to it and located in alignment with the drive pulley 102 of the pump 100 to operate it.

The mounting portion 1100 is for mounting the external drive apparatus to the aircraft so that it the external drive apparatus can drive the hydraulic pump 100. The remaining parts of the external drive apparatus may be permanently or removably associated with the mounting portion 1100. In at least some examples, it may be desirable for the remaining parts of the external drive apparatus to be removably associated with the mounting portion. This may allow for simpler and less cumbersome assembly of the mounting portion 1100 onto the pump 100 by itself compared to assembling the mounting portion 1100 along with the other parts of the external drive apparatus to the pump 100 all at once.

As seen in FIGS. 4 and 5, the mounting portion 1100 has a pivot 1104 onto which the belt drive assembly of the external drive apparatus can be mounted. The pivot 1104 is provided by a pin 1106 which provides two laterally spaced and axially aligned pivot points 1104a and 1104b.

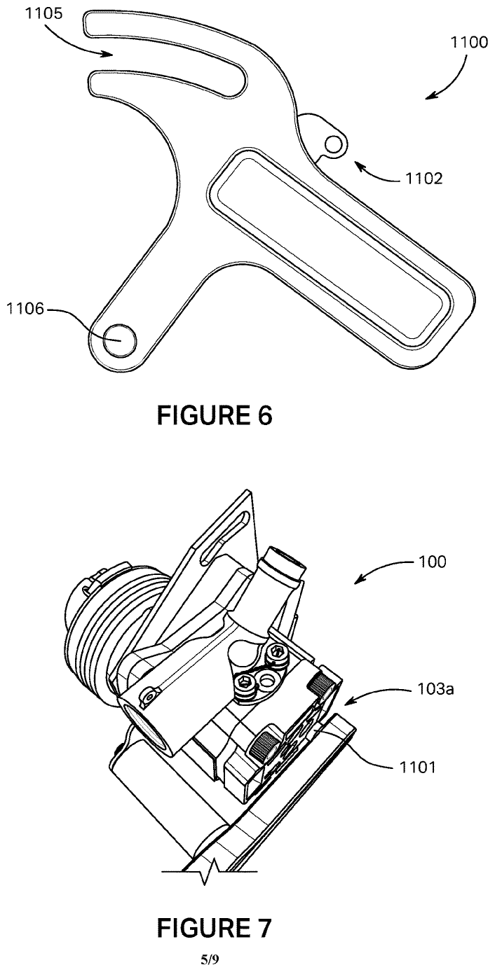

The mounting portion 1100 of FIGS. 4 and 5 also has an arcuate slot 1105. The path of the slot 1105 is an arc about the axis of the pivot points 1104a and 1104b on the pin 1106. The arcuate slot 1105 is radially spaced away from the pivot points 1104a and 1104b. The arcuate nature of the slot 1105 about the pin and its pivot points is illustrated in the side view of FIG. 6.

Once the mounting portion 1100 is mounted to the pump 100, for example as is illustrated in FIGS. 7 and 8 respectively, the remaining parts of the external drive apparatus may be associated with the mounting portion.

FIG. 9 shows a belt drive assembly 1200 and electric motor 1300 of an external drive apparatus which are for assembly to the mounting portion 1100. The belt drive assembly 1200 has a housing 1201. A belt 1202 is partially located within the housing 1201, and partially located outside the housing 1201 presenting a belt loop 1203. Either ends of the belt loop extend from two openings 1214 of the housing 1201. The belt drive assembly 1200 has two slots 1204 each of which are configured to removably receive the pin 1106 of the mounting portion 1100 at the respective two pivot points 1104a and 1104b. When the pin 1106 is received within the slots 1204, the belt drive assembly 1200 is pivotably moveable relative to the mounting portion 1100.

Where a mounting portion 1100 includes an arcuate slot 1105, the belt drive assembly 1200 may include a member 1205 configured to in use slide within the arcuate slot 1105. The sliding of the member 1205 in the arcuate slot 1105 when the pin 1106 is received within the slots 1204 of the belt drive assembly 1200 may act to permit pivoting of the belt drive assembly relative to the mounting portion on the pin 1106, but while the member 1205 is within the arcuate slot 1105, to prevent the removal of the slots 1204 of the belt drive assembly 1200 from being removed from the pin 1106.

In other arrangements, the same functionality of providing a range of relative position of the belt drive assembly 1200 and mounting portion 1100 through which the they can only pivot and not be separated from each other may be provided by a peripheral arcuate surface against which the member 1205 of the belt drive assembly 1200 engages, rather than an arcuate slot as illustrated in for examples FIGS. 6 and 8.

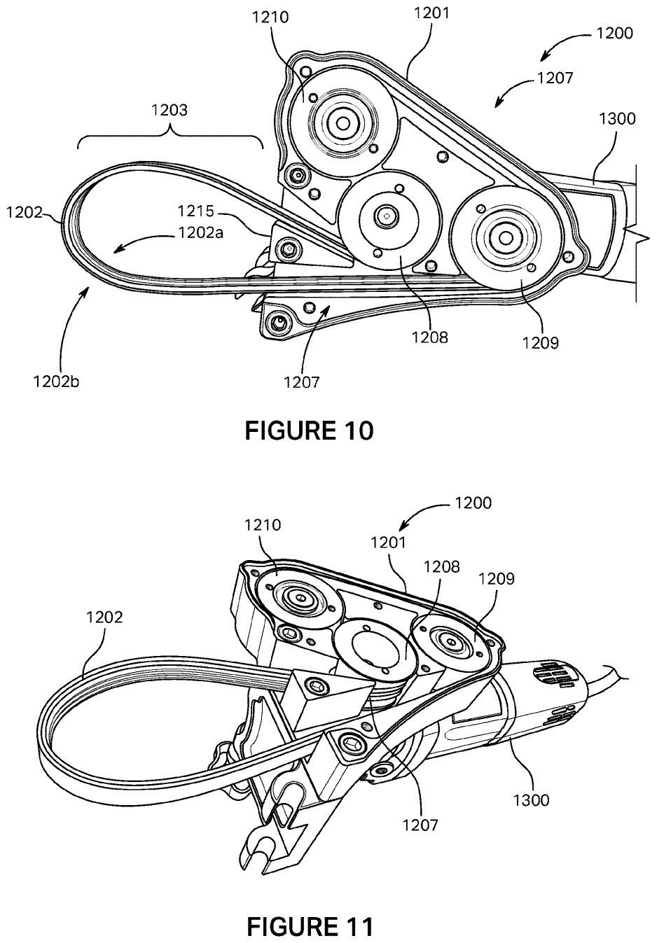

FIGS. 10 and 11 are views of the belt drive assembly 1200 with a cover of the housing 1201 removed. Within the housing 1201 are pulleys 1208-1210 about which the belt 1202 passes. The belt 1202 has an inner face and an outer face.

The housing 1201 defines an enclosed path 1207 about the belt 1202 within the housing 1201. More particularly, the housing 1201 is enclosed about the part of each pulley 1208-1210 around which the belt 1202 passes. The enclosed path which the housing defines for the belt acts to limit the amount of retraction of the belt into the housing when the belt loop 1203 is unloaded. This arrangement allows a minimum desired size of the belt loop 1203 to be always presented outside of the housing. This may improve the convenience and simplicity of associating the belt 1202 with the drive pulley 102 of the pump 100 in use.

As seen in FIGS. 10 and 11, the pulleys 1208-1210 of the belt drive assembly include an input pulley 1208 which to be driven by the electric motor 1300 and two idler pulleys 1209 and 1210. The belt 1202 has an internal belt side 1202a and an external belt side 1202b. According to different pump arrangements, the drive pulley 102 may be configured to be driven by one or more different types of belts, such as a flat or non-grooved belt, a V-belt, poly V-belt, or a toothed belt. In the illustrated arrangement, the drive pulley 102 is configured to be driven by a poly V-belt. The belt 1202 of the belt drive assembly 1200 may be provided to suit the configuration of the drive pulley of the hydraulic pump which is to be driven by the external drive apparatus.

As seen in FIGS. 10 and 11, the internal belt side 1202a has a grooved poly V profile, while the external belt side 1202b is flat.

Where the belt 1202 has a non-flat profile on one or both sides, one or more of the pulleys 1208-1210 of the belt drive assembly may have a profile to correspond to the adjacent profile of the belt.

In other arrangements, irrespective of the profile of the belt 1202, the pulleys 1208-1210 may each have a flat profile. In such arrangements, the pulleys may have a width that is greater than the width of the belt. This may allow for the belt 1202 to walk laterally in use, to accommodate a range of different lateral positions of the drive pulley 102 of the pump 100 relative to the external drive apparatus 1000. This arrangement may allow the external drive apparatus to operate in a range of different laterally displaced positions of the belt relative to the housing 1201.

In some configurations, the width of the pulleys may be about 1.25 to about 3 times the width of the belt.

Where the pulleys 1208-1210 are flat and each of a width greater than the width of the belt 1202, one or more of the pulleys 1208-1210 may be gated to provided lateral limits on the movement of the belt 1202 relative to the pulleys.

As illustrated in FIGS. 9 and 10, each of the input pulley 1208 and idler pulleys 1209 and 1210 have a flat surface and are gated. In this arrangement the gates of the pulleys define the lateral enclosures of the enclosed path 1207 for the belt 1202.

FIGS. 9 and 10 also show a wedge 1215 of the housing 1201 which is provided between the opposed portions of the internal side 1202a of the belt 1202 adjacent the opening of the housing from which the belt loop 1203 is presented. The wedge 1215 forms part of the enclosed path 1207 of the belt, limiting the degree of movement of the belt 1202 within the housing 1201.

The input pulley 1208 is configured to be driven by the electric motor 1300. The input pulley 1208 may be driven directly by the electric motor 1300 or may be driven indirectly through a gearbox. In the illustrated configuration, for example as seen in FIG. 9, the electric motor 1300 is provided as part of an electric power tool that is coupled to the input pulley 1208. Depending on the configuration of the pulleys 1208-1210, the drive speed of the electric motor 1300, and the required drive speed of the drive pulley 102 of the hydraulic pump 100, the power tool may or may not include a gearbox.

The electric motor 1300 may be arranged to be powered by a battery power source or may be connected to a mains power source depending on the requirements of the particular situation.

The electric motor 1300 may be include speed-variable control or may in other arrangements operate at a single fixed speed.

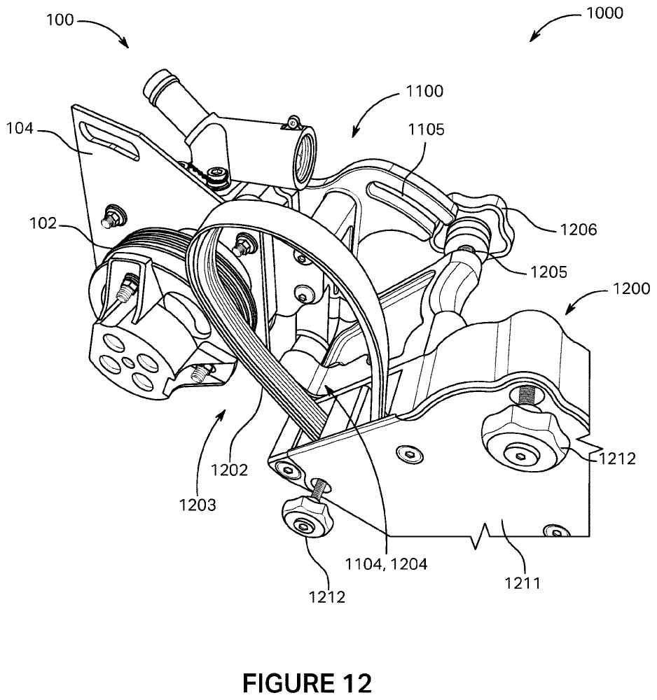

Returning to the association of the external drive apparatus 1000 with the hydraulic pump 100 in use, FIG. 12 shows a mounting portion 1100 mounted to the pump 100 and bracket 104, and the pin 1106 of the mounting portion received by the slots 1204 of the belt drive assembly. As illustrated in FIG. 12, the member 1205 is aligned with the opening of the arcuate slot 1105 but is not yet provided within the arcuate slot. The loop 1203 of the belt 1202 is extends from the housing 1201 of the belt drive assembly. The loop 1203 is limited in its possible retraction within the housing 1201 by the enclosed path 1207 which the housing defines for the belt. As the belt drive assembly 1200 is pivoted on the pin 1106 of the mounting portion, the member 1205 may be caused to enter and slide within the arcuate slot 1105. When sliding within the arcuate slot 1105, the member 1205 acts to restrict the removal of the slots 1204 of the belt drive assembly 1200 from the pin 1106 of the mounting portion 1100, locking the belt drive assembly and mounting portion 1100 together so that they are only pivotable relative each other.

To prepare the external drive apparatus for use, from the arrangement in FIG. 12 the belt drive assembly may be pivoted forwards towards the pump 100. The length of the belt 1202 and length of the arcuate slot 1105 may be configured together to allow the belt 1202 to be passed about the drive pulley 102 of the pump 100 only when the member 1205 is located within the slot 1105. More particularly, the length of the belt and the length of the arcuate slot may be configured together to allow the belt 1202 to be passed about the drive pulley 102 only when the member 1205 is located away from a rearmost portion of the slot. Even more particularly, the length of the belt and the length of the arcuate slot may be configured together to allow the belt 1202 to be passed about the drive pulley 102 only when the member 1205 is located at or towards a frontmost portion of the arcuate slot.

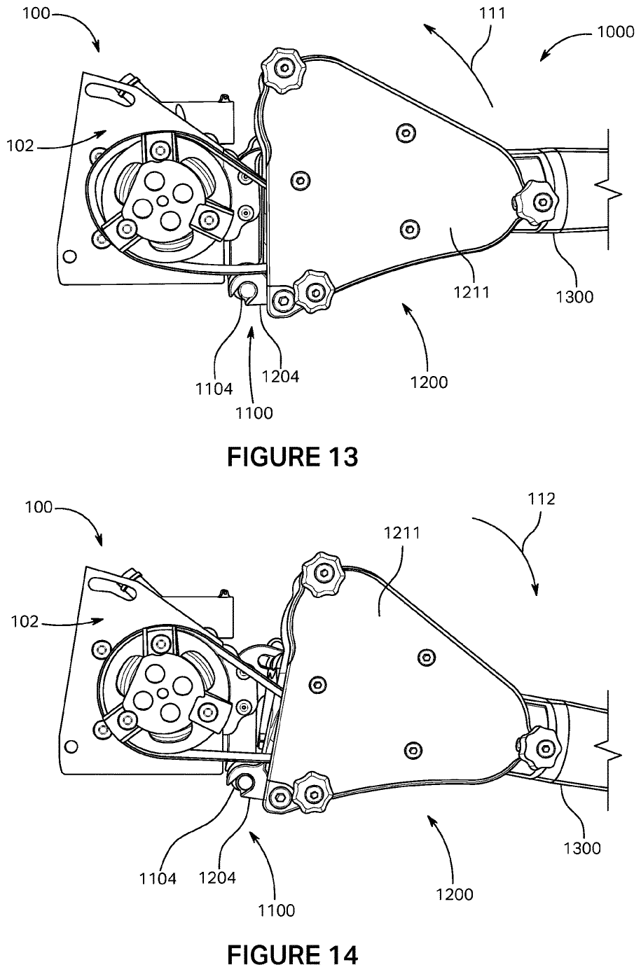

Once the belt 1202 is located about the drive pulley 102 of the pump 100, tension may be required to be applied to the belt for it to suitably turn the drive pulley. Tension may be applied by the rotation of the belt drive assembly on the mounting portion away from the pump 100. FIG. 13 shows a side view of the external drive apparatus 1000 assembled to a pump 100, with the belt 1202 located about the drive pulley 102. To locate the belt 1202 about the drive pulley 102, the belt drive assembly 1200 has been pivoted relative to the mounting portion 1100 in the direction of the arrow 111. As seen in FIG. 13, tension has not been applied to the belt 1202.

FIG. 14 shows the configuration of FIG. 13, but where the belt drive assembly 1200 has been rotated from the position in FIG. 13 in the direction of the arrow 112. This movement adds tension to the belt 1202.

The external drive apparatus 1000 may be configured to self-tension the belt 1202 to the desired amount by controlling the weight of the belt drive assembly 1200 and electric motor 1300, and the spacing of their centre of mass away from the pivot 1104.

The external drive apparatus 1000 may be configured so that when the belt is fully tensioned onto the drive pulley the member 1205 is still located within the arcuate slot. This may ensure safety in operation, by preventing the belt drive assembly 1200 from being inadvertently removed from the mounting portion 1100 in use, such as by vibration.

The member 1205 which is slidable within the arcuate slot 1105 may be configured to selectively be fixable in its position within the arcuate slot 1105. For example, as shown in FIG. 12, a knob 1206 is threaded onto the end of the member 1205. When the member 1205 is located within the arcuate slot 1105, adjustment of the knob 1206 may be used to frictionally engage the body of the mounting portion 1100 adjacent the arcuate slot 1105 between the housing 1201 of the belt drive assembly 1200 and the knob 1206.

This or other equivalent selective fixtures between the mounting portion 1100 and the belt drive assembly 1200 may act to secure the belt 1202 in a desired tensioned condition.

As seen in FIGS. 13 and 14, the cover 1211 has been attached to the housing 1201.

Returning to FIG. 1, the external drive apparatus 1000 is illustrated fully assembled to drive the pump 100. The belt 1202 is located about the drive pulley 102, a desired tension has been applied to the belt by counterrotation of the belt drive assembly 1200 in the direction of the arrow 112 illustrated in FIG. 14. The belt drive assembly 1200 and mounting portion 1100 have been fixed to prevent their relative pivoting by the tensioning of the knob 1206. In this state, the electric motor 1300 may be activated to rotate the belt 1202 and turn the drive pulley 102 of the hydraulic pump, operating the pump and energising the hydraulic system of the aircraft with which the pump is associated.

As seen in FIG. 1, the external drive apparatus 1000 may include a safety shield 1213 to at least partially cover the belt 1202 and drive pulley 102 during operation. As seen in FIG. 1 the safety shield 1213 is made of a transparent material to allow an operator to maintain visibility of the belt 1202 and drive pulley 102 in operation. The safety shield 1213 may slide onto fixtures 1212 which are then used to secure the safety shield 1213 against the housing 1201 of the belt drive assembly 1200.

The use of the external drive apparatus 1000 to drive the belt-driven hydraulic pump 100 of an aircraft may allow for the testing of the hydraulic system and flight controls without requiring the operation of the aircraft's engine. This may expedite the testing of these systems, as well as reducing costs from fuel consumption, and danger to groundcrew from the operating engine, its noise and fumes, and in the case of helicopters and propeller aircraft, moving rotors or propellor blades.

Because the external drive apparatus of the disclosure does not require breaking into the hydraulic system of the aircraft, the simplicity of the associated testing and its safety may be increased.

In the case of helicopters, such as the Airbus AS350 and EC130 which have belt-driven hydraulic pumps, the use of the external drive apparatus of the disclosure may enable post maintenance checks of the hydraulic systems and flight controls to be carried out more safely and completely. Because the engine is not required to operate the hydraulic system, the control surfaces may be taken to their limits safely when the hydraulic system is powered by the external drive apparatus of the disclosure, without the risk of the helicopter tipping over.

Accordingly, the use of the external drive apparatus on the belt-driven hydraulic pump of an aircraft and particularly of a helicopter such as the Airbus AS350 and EC130 may increase the ease and efficiency of testing of the hydraulic systems and control surfaces of these aircraft, while reducing the associated cost by negating the need for breaking into the hydraulic system and the provision of a costly external system which provides its own pressurisation and connects into the aircraft's hydraulic system.

While the external drive apparatus 1000 has been described and illustrated having the mounting portion 1100 first mounted to the pump, then the belt drive assembly 1200 and electric motor 1300 assembled to the mounting portion 1100 and the belt located about the drive pulley of the pump, it will be appreciated that the external drive apparatus 1000 may be mounted to the pump as a single part. Where such an assembly is desired, the belt drive assembly 1200 and mounting portion may not be removable from each other. For example, instead of having slots 1204 which are removably located on the pin 1106, the belt drive assembly 1200 may be permanently pivotably attached to the pin 1106 of the mounting portion 1100.

Where in the foregoing description reference has been made to elements or integers having known equivalents, then such equivalents are included as if they were individually set forth.

Although embodiments have been described with reference to a number of illustrative embodiments thereof, it will be understood by those skilled in the art that various changes in form and details may be made therein without departing from the spirit and scope of the invention as defined by the appended claims. Therefore, the preferred embodiments should be considered in a descriptive sense only and not for purposes of limitation, and also the technical scope of the invention is not limited to the embodiments. Furthermore, the present invention is defined not by the detailed description of the invention but by the appended claims, and all differences within the scope will be construed as being comprised in the present disclosure.

Many modifications will be apparent to those skilled in the art without departing from the scope of the present invention as herein described with reference to the accompanying drawings.

1. An external drive apparatus for a hydraulic pump of an aircraft, the apparatus comprising:
a mounting portion mountable to the aircraft and configured to locate the apparatus relative to a drive pulley of the hydraulic pump of the aircraft,
a belt drive assembly including a belt locatable about the drive pulley when the mounting portion is mounted to the aircraft, and
an electric motor arranged to operate the belt drive assembly to drive the hydraulic pump by its drive pulley and the belt.

2. (canceled)

3. The external drive apparatus of claim 1, wherein the mounting portion is mountable to a body of the hydraulic pump;
the mounting portion includes a locating feature configured to couple with a feature of the body of the pump;
the feature of the body of the pump is a recess, the locating feature comprises a lug which is insertable into the recess, and
the recess is located on an opposite side of the pump from the pulley.

4. (canceled)

5. (canceled)

6. The external drive apparatus claim 2, wherein the recess is a pre-existing cast bore on the body of the pump.

7. The external drive apparatus of claim 3, wherein a profile of the lug corresponds with a profile of the recess, such that when the lug is inserted into the recess, relative rotational movement between the body of the pump and the mounting portion is limited a single degree of freedom.

8. The external drive apparatus of claim 4, wherein when the lug is inserted into the recess, relative linear movement between the body of the pump and the mounting portion is limited to a single degree of freedom.

9. The external drive apparatus of claim 4, , wherein the mounting portion is engaged to the aircraft by at least one fastener, wherein when the at least one fasteners is engaged a longitudinal axis of each at least one fastener is parallel to an axis of insertion of the lug into the recess.

10. (canceled)

11. (canceled)

12. (canceled)

13. The external drive apparatus of claim 6, wherein the mounting portion comprises a pivot and the belt drive assembly includes a slot which is insertable onto the pivot to removably pivotably connect the belt drive assembly and the mounting portion, and
wherein the mounting portion and the belt drive assembly together further comprise an arcuate slot radially spaced away from the pivot and a member slidable therein, and a selective frictional coupling between the arcuate slot and the member, such that the member and slot may slide relative each other but be selectively coupled with each other at a desired location of the member within the arcuate slot.

14. (canceled)

15. The external drive apparatus of claim 7, wherein when the mounting portion is mounted to the aircraft and the belt drive assembly is pivotably connected to the mounting portion, a combined centre of mass of the belt drive assembly and the electric motor are located laterally away from both the hydraulic pump of the aircraft and the pivotable connection of the belt drive assembly with the mounting portion, such that a weight of the belt drive assembly and electric motor provide tension to the belt about the drive pulley of the hydraulic pump.

16. (canceled)

17. The external drive apparatus of claim 1, wherein the belt drive assembly has a housing and projecting therefrom a loop of the belt, and
the belt drive assembly is configured to substantially prevent a retraction of the loop of the belt into the housing between an in-use condition where the loop of the belt is located about the drive pulley of the hydraulic pump and a non-use condition where the loop of the belt is unrestrained.

18. (canceled)

19. The external drive apparatus of claim 9, wherein the housing of the belt drive assembly defines an enclosed path for the belt about one or more pulleys and an outlet of the housing from which the loop of the belt projects.

20. (canceled)

21. The external drive apparatus of claim 10, wherein a width of the one or more pulleys and the enclosed path of the belt drive assembly is greater than a width of the belt, such that the belt is operable in different laterally displaced positions relative to the housing to accommodate a range of lateral locations of the drive pulley of the hydraulic pump relative to the mounted location of the belt drive assembly.

22. (canceled)

23. The external drive apparatus of claim 11, wherein the belt is a grooved belt for locating about a grooved drive pulley of the hydraulic pump, but the one or more pulleys of the housing are non-grooved.

24. (canceled)

25. The external drive apparatus of claim 12, wherein the one or more pulleys of the belt drive assembly comprise an input pulley which is driveable by the electric motor and two idler pulleys, and
the enclosed path for the belt comprises a path within the housing that is enclosed above and below the belt between each successive one of the input pulley, the two idler pulleys, and the opening of the housing.

26. (canceled)

27. (canceled)

28. (canceled)

29. The external drive apparatus of claim 1, wherein the electric motor is powered by a battery power source.

30. (canceled)

31. The external drive apparatus of claim 1, wherein the electric motor is comprised as part of an electric power tool.

32. An auxiliary hydraulic pump drive apparatus, the apparatus being mountable to an aircraft and comprising an electric motor driven belt which, when the tool is mounted to the aircraft, is configured to align with a drive pulley of a hydraulic pump of the aircraft and when the belt is engaged therewith, to selectively operate the hydraulic pump in the absence of operation of the aircraft engine.

33. An aircraft maintenance tool comprising:
a mounting portion mountable to the aircraft and configured to locate the tool relative to a drive pulley of a hydraulic pump of an aircraft,
a belt drive assembly including a belt locatable about the drive pulley when the mounting portion is mounted to the aircraft, and
an electric motor arranged to operate the belt drive assembly to drive the hydraulic pump by its drive pulley and the belt,
wherein the tool is operable to provide auxiliary mechanical operation of an engine-driven hydraulic pump of the aircraft, having a flight-ready hydraulic system but for the removal of a drive belt from a drive pulley of the hydraulic pump.
